(19) United States
(12) Patent Application Publication
(10) Pub. No.: US 2012/0183205 A1
(43) Pub. Date: Jul. 19, 2012

(54) METHOD FOR DISPLACEMENT MEASUREMENT, DEVICE FOR DISPLACEMENT MEASUREMENT, AND PROGRAM FOR DISPLACEMENT MEASUREMENT

(75) Inventors: Hideki Shimamura, Tokyo (JP); Hiroyuki Shimomura, Tokyo (JP); Kikuo Tachibana, Tokyo (JP); Lin Zhu, Tokyo (JP); Kazunori Fujisawa, Tokyo (JP)

(73) Assignees: INCORPORATED ADMINISTRATIVE AGENCY PUBLIC WORKS RESEARCH INSTITUTE, TSUKUBA-SHI, IBARAKI (JP); PASCO CORPORATION, Tokyo (JP)

(21) Appl. No.: 13/394,737

(22) PCT Filed: Sep. 8, 2010
(86) PCT No.: PCT/JP2010/065370

§ 371 Date: Apr. 3, 2012

(30) Foreign Application Priority Data
Sep. 8, 2009 (JP) 2009-207026

(51) Int. Cl. G06K 9/48; G06K 9/00

(52) U.S. Cl. 382/154

(57) ABSTRACT

Measurement of 3D displacement based on successively captured images of an object becomes difficult to be performed due to a load imposed on an operator along with an increase of the number of target portions defined on the object and that of time steps for displacement measurement. A device for displacement measurement executes stereo measurement relative to a stereo image to generate 3D shape information and orthographically projected image of an object for each time, and tracks the 2D image of the target portion through pattern matching between orthographically projected images at successive times to obtain a 2D displacement vector. The device for displacement measurement converts the start point and the end point of the 2D displacement vector into 3D coordinates, using the 3D shape information, to obtain a 3D displacement vector.

### TECHNICAL FIELD

The present invention relates to a method for displacement measurement, a device for displacement measurement, and a program for displacement measurement for displacement measurement of an object, using stereo pair images.

### BACKGROUND ART

Displacement measurement technique is important in, e.g., analysis on and measures against landslide, earth works, and construction and management of earth structure and so forth. For example, as to landslide, displacement measurement is used to understand a series of kinetic behaviors from occurrence to completion of a landslide and its mechanism. When understanding on landslide phenomena can be deepened based on such a use of displacement measurement, it will become possible to estimate a shape of a slide surface, to develop more sophisticated numerical calculation methods, and to study effective prevention measures against landslide.

Various methods have been proposed for displacement measurement technique. As to landslide phenomena in particular, a method has been known in which a reflection panel is disposed in advance on an object to be measured, and the distance is measured by irradiating light and observing reflected light. In addition, a method using a photogrammetry technique has been also known. A method using a photogrammetry technique does not require disposition of a reflection panel or the like, and thus is preferably used in landslide observation covering a wider region and in a place hardly accessible. Conventionally, in landslide analysis using a photogrammetry technique, deformation in the landform due to landslide is observed, using aerial photos and ground photos before and after the landslide, and landform data.

According to a conventional basic method for analysis on deformation in a landform, a person detects a displacement tracking point by viewing an image, and determines correspondence between displacement characteristic points in the respective images through manual operation to obtain a displacement vector.

### PRIOR ART DOCUMENT

### Patent Document

Patent Document 1: Japanese Patent Laid-open Publication N 2000-251059

### DISCLOSURE OF THE INVENTION

### Problems to be Solved by the Invention

Recent development of digital camera technology and photogrammetry and image analysis technique contributes to achievement of detailed observation and precise analysis on a high speed moving body, based on an image captured from a remote place. However, a technique that effectively incorporates the technology development to perform efficient analysis on displacement, such as a landslide or the like, using successively captured images has not yet been developed. In an analysis on a case, such as landslide, in which the number of displacement characteristic points could be enormous, it is not practicable to perform successive image capturing at a very long period according to a conventional method which largely relies on a manual operation, and it is not easy to accurately and efficiently track displacement and to obtain a displacement vector according to a conventional method.

The present invention has been conceived in order to solve the above described problems, and aims to provide a method for displacement measurement, a device for displacement measurement, and a program for displacement measurement for efficiently detecting and highly accurately measuring 3D displacement of a target portion of an object, based on successively captured images of an object.

### Means to Solving the Problems

A method for displacement measurement according to the present invention obtains, based on stereo images of an object at two or more times, a 3D displacement vector of a target portion of the object between the times, and comprises tracking processing of tracking a 2D image of the target portion that is set at a time on a tracking image that is based on at least one of images that constitute the stereo image by executing pattern matching between the respective times; and 3D coordinate calculation processing of obtaining 3D coordinates of the target portion, based on a position of the 2D image in the tracking image, by performing stereo measurement using the stereo image, and displacement vector calculation processing of obtaining the 3D displacement vector, based on the 3D coordinates of the target portion at the respective times.

According to the present invention, in the tracking processing, while using an orthographically projected image of the object as the tracking image, the 2D image of the target portion may be tracked in the orthographically projected image, and the 3D coordinate calculation processing may include processing of generating the orthographically projected image and 3D shape information of the object that describes a position in the orthographically projected image and a height, and processing of obtaining the 3D coordinates of the target portion, using the 3D coordinate shape information.

According to the present invention, in the tracking processing, while using one of the images that constitute the stereo image as the tracking image, a tracking point corresponding to a position of the 2D image of the target portion in the one of the images may be obtained, and in the 3D coordinate calculation processing, a corresponding point of the tracking point in another of the images that constitutes the stereo image at each of the times may be extracted, and the stereo measurement may be executed relative to the tracking point and the corresponding point to thereby obtain the 3D coordinates of the target portion.

A device for displacement measurement according to the present invention obtains, based on stereo images of an object at two or more times, a 3D displacement vector of a target portion of the object between the times, and comprises a tracking unit for tracking a 2D image of a target portion that is set at a time on a tracking image that is based on at least one of images that constitute the stereo image by executing pattern matching between the respective times; and a 3D coordinate calculation unit for obtaining 3D coordinates of the target portion, based on a position of the 2D image in the tracking image, by performing stereo measurement using the stereo image, and a displacement vector calculation unit for obtaining the 3D displacement vector, based on the 3D coordinates of the target portion at the respective times.

A program for displacement measurement according to the present invention is a program for causing a computer to function as means for displacement measurement for obtaining, based on stereo images of an object at two or more times, a 3D displacement vector of a target portion of the object between the times, and to attain a tracking function of tracking a 2D image of a target portion that is set at a time on a tracking image that is based on at least one of images that constitute the stereo image by executing pattern matching between the respective times; and a 3D coordinate calculation function of obtaining 3D coordinates of the target portion, based on a position of the 2D image in the tracking image, by performing stereo measurement using the stereo image; and a displacement vector calculation function of obtaining the 3D displacement vector, based on the 3D coordinates of the target portion at the respective times.

### Effect of the Invention

According to the present invention, 3D displacement of a target portion of an object can be efficiently detected and highly accurately measured, based on successively captured images of the object.

### BRIEF DESCRIPTION OF THE DRAWINGS

FIG. 1 is a schematic block diagram of a displacement measurement system according to an embodiment of the present invention;

FIG. 2 is a schematic flowchart of processing by a processing unit according to a first embodiment;

FIG. 3 is a schematic diagram explaining image tracking processing;

FIG. 4 is a schematic diagram showing 2D displacement vector obtained in the processing shown in FIG. 3;

FIG. 5 is a schematic diagram of 3D mesh data; and

FIG. 6 is a schematic diagram explaining conversion processing from 2D displacement to 3D displacement, using 3D mesh data;

FIG. 7 is a schematic flowchart of processing by a processing unit according to a second embodiment.

### MODE FOR CARRYING OUT THE INVENTION

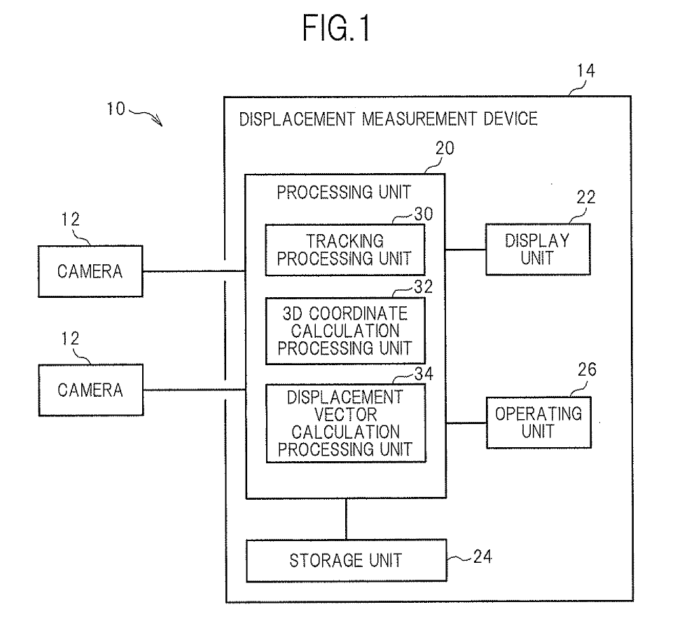

In the following, a displacement measurement system 10 according to an embodiment of the present invention (hereinafter referred to as an embodiment) will be described based on accompanying drawings. FIG. 1 is a schematic block diagram of the displacement measurement system 10. The structure shown in FIG. 1 is common to the first and second embodiments to be described below. The displacement measurement system 10 includes a plurality of cameras 12 and a displacement measurement device 14.

The plurality of cameras 12 include at least two cameras, and placed so as to be able to capture a stereo image of an object for displacement measurement. In this embodiment, e.g., landslide will be described as an object for measurement, and the camera 12 is installed in a place from which an observational target point for landslide, such as a slope surface, a cliff, or the like, can be observed and the entire observation area can be covered in image capturing, and which is considered safe. For example, the plurality of cameras 12 are placed basically in the lateral direction with a distance ensured therebetween, and capture images of an observational target point from different point of views to thereby provide a stereo image composed of a pair of still pictures. The respective cameras 12 successively capture images in a synchronous manner, and the captured images are input to the displacement measurement device 14. Note that a frame rate for successive image capturing is determined in consideration of a landslide speed, the distance from the camera 12 to an observational target point, and so forth, to be such a high speed that allows tracking processing between successive frames. Note that a video camera is usable as a camera here. Further, although a camera 12 for outputting digital image data is suitable for the processing by the displacement measurement device 14, a camera for outputting an analog signal is also usable. In the latter case, the displacement measurement device 14 executes A/D conversion.

The displacement measurement device 14 includes a processing unit 20, a display unit 22, a storage unit 24, and an operating unit 26. The processing unit 20 includes a tracking processing unit 30, a 3D coordinate calculation processing unit 32, and a displacement vector calculation processing unit 34. For example, the displacement measurement device 14 can be implemented using a computer. The CPU of the computer constitutes the processing unit 20, and the tracking processing unit 30, the 3D coordinate calculation processing unit 32, and the displacement vector calculation processing unit 34 can be implemented by a program executed by the CPU.

Further, the storage unit 24 includes a hard disc, or the like, incorporated into a computer or the like. For example, the storage unit 24 holds data on a stereo image input from the camera 12 for a period of time necessary for stereo measuring processing and tracking processing. Still further, orientation elements related to image capturing by the camera 12 and necessary in stereo measuring processing are stored in advance in the storage unit 24. Note that the orientation elements include external orientation elements (projection central position, posture) and internal orientation elements (principal point, focal distance, image resolution, and the like), and various functions for conversion between the coordinates in the actual space where an observation area is present and image coordinates can be given using these orientation elements.

The display unit 22 is an image display device, such as a liquid crystal monitor or the like, and the operating unit 26 includes a keyboard, a mouse or the like.

The tracking processing unit 30 executes pattern matching processing, e.g., between consecutive image capturing times with respect to a tracking image that is based on at least one of the images constituting a stereo image captured by the camera 12, and as to a target portion that is set on an object at a certain time, tracks the 2D image of the target portion on the tracking image. Note that setting a target portion can be made on, e.g., a tracking image, and that two or more target portions may be set on the image. The setting is made by an operator by operating the operating unit 26 while looking at a tracking image shown on the display unit 22. Further, while a feature of a target portion in an image may be stored in advance in the storage unit 24, and the processing unit 20 may extract a part coincident with the feature at the start of tracking, or the like, and set the extracted part as a target portion. For example, a tree, a rock, a structure on the ground, or the like may be set as a target portion.

Based on the position of the 2D image of the target portion in a tracking image, the 3D coordinate calculation processing unit 32 obtains 3D coordinates of the target portion at an image capturing time related to the tracking image through stereo measuring processing executed relative to a stereo image.

Based on the 3D coordinates of the target portion at the respective times, the displacement vector calculation processing unit 34 obtains a 3D displacement vector.

In the above, a structure common to the first and second embodiments has been described. The displacement measurement systems 10 according to the first and second embodiments are difference in the processing executed by the processing unit 20. This processing according to the respective embodiments will be described below.

### [Processing in First Embodiment]

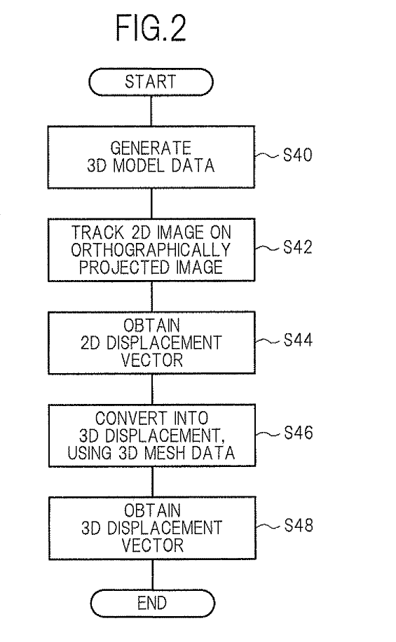

FIG. 2 is a schematic flowchart of the processing executed by the processing unit 20 in the first embodiment. Specifically, the processing unit 20 generates 3D model data based on a stereo image captured by the camera 12 (S40). This generation processing is executed by the 3D coordinate calculation processing unit 32 of the processing unit 20.

The 3D model data is composed of 3D mesh data (3D shape information) and an orthographically projected image (ortho image). The 3D mesh data is of the 3D coordinates of an object surface obtained through stereo matching processing based on a stereo image, and is expressed according to, e.g., an xyz orthogonal coordinate system. Specifically, a grid defined by x and y coordinates, which are defined with, e.g., a predetermined interval, is set on the xy plane, or a horizontal plane, and a z coordinate for height is given to the grid.

Meanwhile, the orthographically projected image is an image of an object projected onto a horizontal plane. The 3D coordinate calculation processing unit 32 processes a stereo image captured by the camera 12 at each time to thereby generate 3D model data at the time.

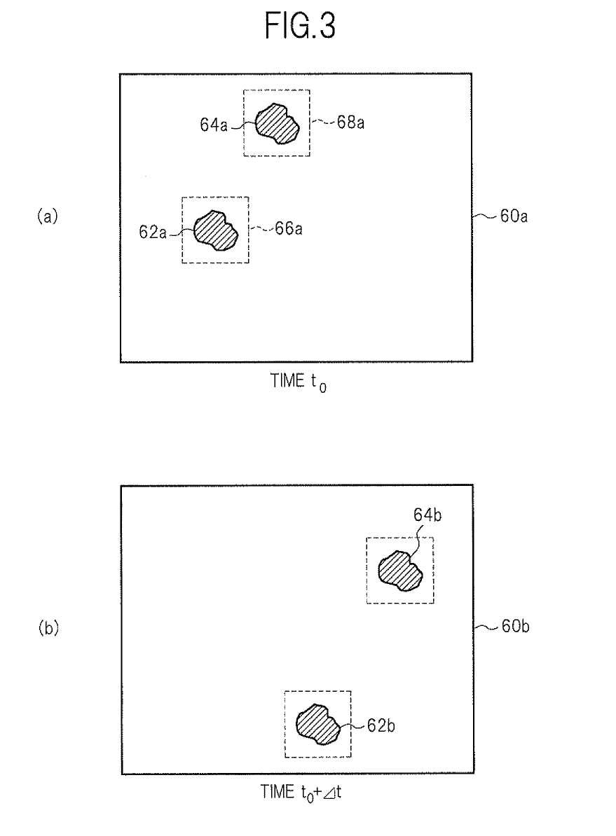

Using the orthographically projected image as a tracking image, the tracking processing unit 30 tracks the 2D image of the target portion in the orthographically projected image (S42) to obtain a 2D displacement vector (S44). FIG. 3 is a schematic diagram explaining the processing at S42 for the tracking in an orthographically projected image. Specifically, FIG. 3A shows the 2D images 62a, 64a of target portions in the orthographically projected image 60a at a preceding time t₀. Thereafter, using as a correlation template the partial images 66a, 68a containing the 2D images 62a, 64a, respectively, pattern matching processing is executed relative to an orthographically projected image 60b at a subsequent time t₀+Δt. As a result, as shown in FIG. 3B, the 2D images 62b, 64b of the target portions in the orthographically projected image 60b at the time t₀+Δt are determined. In the pattern matching processing, for example, a brightness distribution pattern of the correlation template resembles which part of a subsequent orthographically projected image 60b is determined.

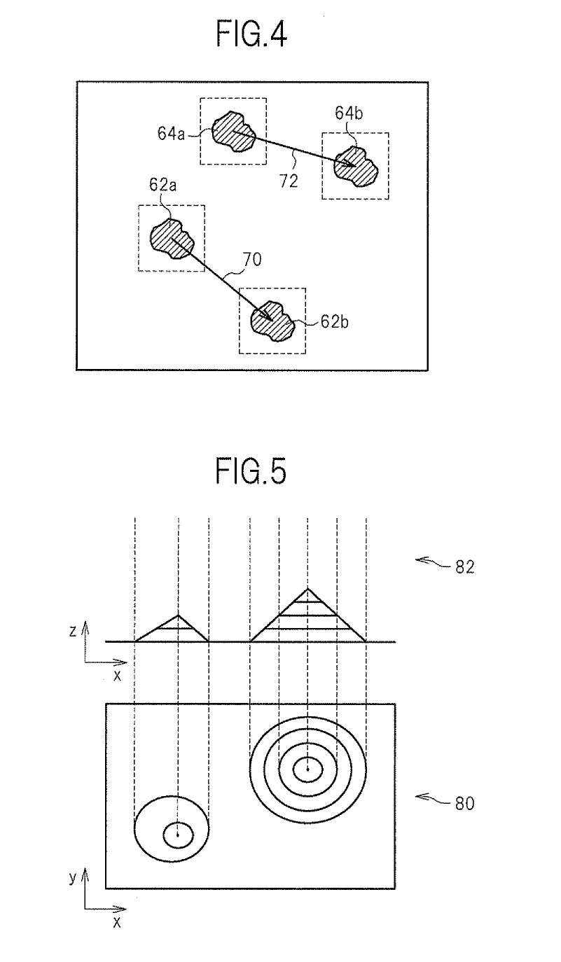

In the pattern matching processing, it is determined that the target portion corresponding to the 2D image 62a corresponds to the 2D image 62b in the orthographically projected image 60b at the subsequent time, and similarly, that the target portion corresponding to the 2D image 64a corresponds to the 2D image 64b. That is, correspondence between 2D images at two respective times t₀ and t₀+Δt is obtained for each target portion. With the above, the coordinates of the 2D image at the time t₀, that is, the start point of the 2D displacement vector, and those at the time t₀+Δt, that is, the end point of the same, can be obtained (S44). FIG. 4 is a schematic diagram showing 2D displacement vectors 70, 72 having start points at the respective positions of the 2D images 62a, 64a at the time t₀ and end points at the respective positions of the 2D images 62b, 64b at the time t₀+Δt.

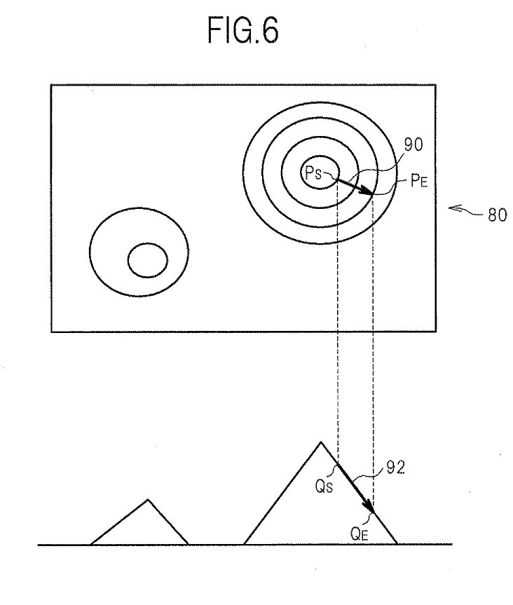

The processing unit 20 converts the 2D displacement obtained on the orthographically projected image into 3D displacement, using the 3D mesh data (S46), to obtain a 3D displacement vector (S48). FIG. 5 is a schematic diagram showing the above mentioned 3D mesh data, including a projection diagram 80 related to projection onto the xy plane, or a horizontal plane, and a projection diagram 82 related to projection onto the zx plane. While the orthographically projected image used to obtain the 2D displacement corresponds to the projection diagram 80 related to projection onto the xy plane, the 2D displacement vector between the two times t₀ and t₀+Δt is projected onto the projection diagram 80. FIG. 6 is a schematic diagram explaining the conversion processing at S46 using the 3D mesh data. FIG. 6 shows a 2D displacement vector 90 of 3D mesh data placed on the projection diagram 80 and the 3D displacement vector 92 obtained based on the 2D displacement vector 90. The 3D coordinate calculation processing unit 32 imparts to the start point P_{S} and the end point P_{E} of the 2D displacement vector on the projection diagram 80, z coordinates at the respective positions, based on the 3D mesh data, to thereby establish correspondence between the points P_{S} and P_{E} and the points Q_{S} and Q_{E}, respectively, in the 3D space. With the above, the coordinates of the start point Q_{S} and the end point Q_{E} of the 3D displacement vector can be obtained (S48).

The displacement vector calculation processing unit 34 obtains a 3D displacement vector, based on the coordinates of the points Q_{S} and Q_{E}.

### [Processing in Second Embodiment]

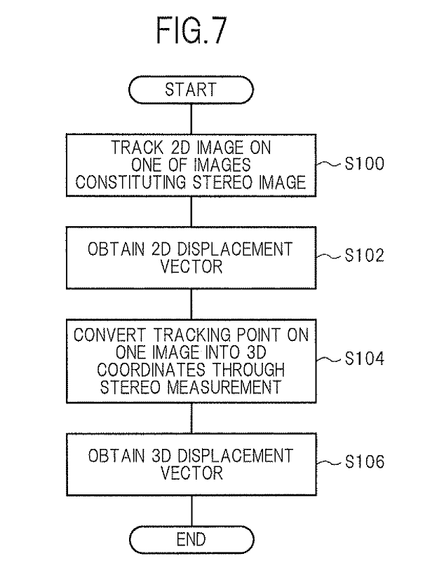

FIG. 7 is a schematic flowchart of the processing executed by the processing unit 20 according to the second embodiment. Specifically, using one of the images constituting a stereo image captured by the camera 12 as a tracking image, the tracking processing unit 30 tracks the 2D image of the target portion in the respective images that are obtained time serially at the respective times (S100) to obtain a 2D displacement vector (S102). Specific content of the processing is similar to that of the processing at S42, S44, described in the first embodiment, and accordingly, FIGS. 3 and 4 for the first embodiment and the description thereof are included here as well. In the processing at S100 and S102 of obtaining the 2D displacement vectors 70, 72, time serial positions of the 2D image (tracking point) of the target portion in one of the images constituting a stereo image, or a tracking image, can be obtained.

The 3D coordinate calculation processing unit 32 extracts a corresponding point of the tracking point in the other one of the images constituting the stereo image at the respective times, and executes stereo measuring processing relative to the tracking point and the corresponding point to obtain the 3D coordinates of the target portion at the respective times (S104).

The displacement vector calculation processing unit 34 obtains a 3D displacement vector having a start point at the 3D coordinates Qₛ of the target portion at the preceding time of two times for obtaining a 3D displacement vector and an end point at the 3D coordinates Q_{E} at the subsequent time (S106).

The displacement measurement systems 10 according to the first and second embodiments both aim to obtain a 3D displacement vector in an example of landslide. However, the present invention is applicable to a field other than landslide, for example, to a wider range of landslide disasters and to understanding of behavior of an object or liquid in an experiment on destruction and deformation of an object, and the like.

Further, the displacement measurement device 14 is applicable not only to on-line processing of an image captured by the camera 12 on a real time basis, but also to off-line processing of an image captured beforehand and input later.

1. A method for displacement measurement for obtaining, based on stereo images of an object at two or more times, a 3D displacement vector of a target portion of the object between the times, comprising:
tracking processing of tracking a 2D image of the target portion that is set at a time on a tracking image that is based on at least one of images that constitute the stereo image by executing pattern matching between the respective times; and
3D coordinate calculation processing of obtaining 3D coordinates of the target portion, based on a position of the 2D image in the tracking image by executing stereo measurement relative to the stereo image; and
displacement vector calculation processing of obtaining the 3D displacement vector, based on the 3D coordinates of the target portion at the respective times.

2. The method for displacement measurement according to claim 1, wherein
in the tracking processing, while using an orthographically projected image of the object as the tracking image, the 2D image of the target portion is tracked on the orthographically projected image, and
the 3D coordinate calculation processing includes
processing of generating the orthographically projected image and 3D shape information of the object that describes a position on the orthographically projected image and a height, and
processing of obtaining the 3D coordinates of the target portion, using the 3D coordinate shape information.

3. The method for displacement measurement according to claim 1, wherein
in the tracking processing, while using one of the images that constitute the stereo image as the tracking image, a tracking point corresponding to a position of the 2D image of the target portion on the one of the images is obtained, and
in the 3D coordinate calculation processing, a corresponding point of the tracking point in another of the images that constitutes the stereo image at each of the times is extracted, and the stereo measurement is executed relative to the tracking point and the corresponding point to thereby obtain the 3D coordinates of the target portion.

4. A device for displacement measurement for obtaining, based on stereo images of an object at two or more times, a 3D displacement vector of a target portion of the object between the times, comprising:
tracking means for tracking a 2D image of a target portion that is set at a time on a tracking image that is based on at least one of images that constitute the stereo image by executing pattern matching between the respective times; and
3D coordinate calculation means for obtaining 3D coordinates of the target portion, based on a position of the 2D image in the tracking image, by performing stereo measurement relative to the stereo image; and
displacement vector calculation means for obtaining the 3D displacement vector, based on the 3D coordinates of the target portion at the respective times.

5. A program for displacement measurement for causing a computer to function as means for displacement measurement for obtaining, based on stereo images of an object at two or more times, a 3D displacement vector of a target portion of the object between the times, the program for causing the computer to attain:
a tracking function of tracking a 2D image of a target portion that is set at a time on a tracking image that is based on at least one of images that constitute the stereo image by executing pattern matching between the respective times; and
a 3D coordinate calculation function of obtaining 3D coordinates of the target portion, based on a position of the 2D image in the tracking image, by performing stereo measurement relative to the stereo image; and
a displacement vector calculation function of obtaining the 3D displacement vector, based on the 3D coordinates of the target portion at the respective times.
